(19) United States
(12) Patent Application Publication
(10) Pub. No.: US 2014/0342035 A1
(43) Pub. Date: Nov. 20, 2014

(54) Effect of a Green and Black Tea Extract Formulation on Exercise Performance

(71) Applicant: Kemin Industries, Inc., Des Moines, IA (US)

(72) Inventors: Michael Ceddia, Ankeny, IA (US); Kelli Herrlinger, Johnston, IA (US); Diana Chirouzes, Castagnola (CH); Yvonne Chukwumah, Des Moines, IA (US); Brandon Lewis, Johnston, IA (US)

(73) Assignee: Kemin Industries, Inc., Des Moines, IA (US)

(21) Appl. No.: 14/277,188

(22) Filed: May 14, 2014

Related U.S. Application Data
(60) Provisional application No. 61/823,215, filed on May 14, 2013.

(51) Int. Cl. A23F 3/16; A23L 1/29

(52) U.S. Cl. CPC A23F 3/163; A23L 1/293
USPC 426/2; 426/597

(57) ABSTRACT

A blend of extracts of green tea and black tea improves exercise performance and recovery.

### RELATED APPLICATIONS

This application claims priority to U.S. Patent Application Ser. No. 61/823,215, filed May 14, 2013, and incorporated herein in its entirety by this reference.

### BACKGROUND OF THE INVENTION

Recovery after exercise is important for athletes and recreationally active individuals. High-intensity exercise is associated with a decrease in power and overall performance.¹⁻⁴ The decrease in performance, which can be associated with delayed onset muscle soreness (DOMS), is usually observed about 24 hours post-exercise and can last as long as 5-7 days post-exercise.⁴⁻⁶ The consensus of research suggests that decreases in performance occur due to muscle micro-trauma, which, in turn, sets off a cascade of inflammatory and oxidative stress related events. Accordingly, any intervention that could improve performance in the days following exercise would allow an athlete to train more frequently and at higher intensities with less discomfort.^{4,7} Several scientific reports have shown the ability of certain foods and food extracts to decrease detrimental effects that occur following a bout of intense exercise.^{6,8,9} Overall, these affects appear to be mediated by attenuating inflammation and oxidative stress. A food source that has been shown to have anti-oxidant and anti-inflammatory effects is tea or tea constituents.¹⁰⁻¹⁴

In general, both green and black teas contain anti-oxidant and anti-inflammatory properties, which may be beneficial to athletes during training and competition periods. Although extracts of these teas have been examined independently, they have not been examined in combination. This latter point is important because while both teas have similar properties, they also have complimentary effects. For example, the theaflavins found in black tea have been suggested to decrease oxidative stress and inflammation resulting from various physiological stressors.¹⁵⁻¹⁷ The proposed mechanism of action of theaflavins is their ability to reduce oxidative stress via radical-scavenging.^{12,14,16,18,19} However, most of the antioxidant and anti-inflammatory effects of theaflavins have been examined with regards to disease.^{10,12,19} There is little information regarding the effects of black tea on inflammation, oxidative stress, and related systemic responses to exercise or on the exercise-induced stress model in humans. To date, we are aware of only one study showing a positive effect of theaflavins on performance in an exercise-induction model.⁸ In this study, Arent and colleagues found that a 1,760 mg daily dose of a black tea extract was able to attenuate muscle soreness and oxidative stress while improving exercise performance in the days following a high-intensity anaerobic exercise stimuli designed to induce muscle soreness.⁸

Green tea also has potent antioxidant qualities and has also been shown to increase lipid utilization during exercise and may allow for improved exercise capacity in mice and humans.^{11,13,20,21} Moreover, epidemiological, clinical and experimental studies have established a positive correlation between green tea consumption and cardiovascular health.¹⁰ The primary component in green tea are catechins, which have been shown to exert vascular protective effects through multiple mechanisms including anti-oxidative, anti-hypertensive, anti-inflammatory, anti-proliferative, anti-thrombogenic, and lipid lowering effects.^{10,14} Tea catechins are also known to stimulate antioxidant activity by scavenging free radicals, inhibiting pro-oxidant enzymes and stimulating antioxidant enzymes. The anti-inflammatory activities of catechins may be due to their suppression of leukocyte adhesion to endothelium and subsequent transmigration through inhibition of transcriptional factor NF-kappa B-mediated production of cytokines and adhesion molecules both in endothelial cells and inflammatory cells.^{10-13,21-26}

The goal of the current study was to examine 12 weeks of supplementation using a low or high dose of a combined green and black tea extract on muscle performance, DOMS, inflammation, muscle damage, oxidative stress and hormonal alterations following an eccentric bout of exercise.

### SUMMARY OF THE INVENTION

The invention consists of a blend of green tea and black tea extracts that are effective at improving exercise performance and recovery. The combined tea extracts are standardized to contain a specified amount of tea polyphenols, theaflavins, and epigallocatechins. Amounts of polyphenols are in the range from about 50 mg/day to about 4000 mg/day. Amounts of theaflavins are in the range from about 1.5 mg/day to about 500 mg/day. Amounts of epigallocatechins are in the range from about 6 mg/day to about 250 mg/day. Supplementation with the combined tea extract over an effective period of time significantly increased the peak torque of subjects post exercise, an increase in average power post exercise and an increase in the minimum torque post exercise. A preferred embodiment of the invention is a combination of water-extracted green tea and black tea, known as AssuriTEA® Sport (ATS, Kemin Foods, L.C., Des Moines, Iowa). AssuriTEA® Sport is standardized to contain a minimum 40% total polyphenols, minimum 1.3% theaflavins, 5-8% epigallocatechin-3-gallate, and 7-13% caffeine.

AssuriTEA Sport was administered to trained men in a randomized, double-blind, placebo controlled study as a novel extract platform for evaluation of performance and recovery. Clinical trial results demonstrated its effectiveness in attenuation of the muscle strength and power losses after exercise by increasing serum antioxidant capacity and by decreasing muscle soreness. This may be occurring through improved glucose recovery and decreased muscle damage (as shown by normalization of cortisol and creatine phosphokinase levels, respectively), To our knowledge, this was the first study exploring the effects of a blended green and black tea extract on post exercise recovery

### BRIEF DESCRIPTION OF THE FIGURES

FIG. 1 is a CONSORT schematic outlining the overall study from recruitment through follow-up.

FIG. 2 is a schematic outlining the testing procedures.

FIG. 3 is a chart of Biodex peak torque at 24 hours pre- (visit 5) and post- (visit 9) supplementation with AssuriTEA Sport (high=2 g/d, low=1 g/d) or placebo; the dashed line represents the Biodex peak torque achieved pre-exercise; *p=0.036 versus the baseline.

FIG. 4 is a chart of Biodex peak torque at 48 hours pre- (visit 6) and post- (visit 10) supplementation with AssuriTEA Sport (high=2 g/d, low=1 g/d) or placebo; the dashed line represents the Biodex peak torque achieved pre-exercise; *p=0.0256 versus baseline; **p=0.011 versus the change observed in the placebo.

FIG. 5 is a chart of Biodex average power 24 hours post exercise, pre- (visit 5) and post-(visit 9) supplementation with AssuriTEA Sport (High=2 g/d, Low=1 g/d) or placebo; the dashed line represents the Biodex average power achieved pre-exercise; *p=0.0162 visit 9 versus visit 5; **p=0.0788 versus the change observed in the placebo.

FIG. 6 is a chart of Biodex average power 48 hours post exercise pre- (visit 6) and post-(visit 10) supplementation with AssuriTEA Sport (high=2 g/d, low=1 g/d) or placebo; the dashed line represents the Biodex average power achieved pre-exercise; *p=0.054 versus the change observed in the placebo.

FIG. 7 is a chart of the ferric reducing antioxidant power pre- (visit 4) and post- (visit 8) supplementation with AssuriTEA Sport. Mean for treatment represents the combined treatment groups (high=2 g/d and low=1 g/d); *p=0.0385 versus the change observed in the placebo group.

FIG. 8 is a chart of Biodex peak torque 24 (visit 9), 48 (visit 10), and 96 (visit 11) hours post exercise following 12 weeks of supplementation with AssuriTEA Sport (high=2 g/d, low=1 g/d) or placebo; the dashed line indicates the strength reported as visit 8 pre-exercise; *p<0.05 versus placebo; **p=0.0945 versus placebo.

FIG. 9 is a chart of the ferric reducing antioxidant power (FRAP) following 12 weeks of supplementation with AssuriTEA Sport (high=2 g/d, low=1 g/d) or placebo; serum measurements were taken pre and at several time points post exercise; within and between group comparisons were detected; *p<0.05 versus the within group V8 pre-exercise level; +p<0.1 change from V8 pre-exercise versus change observed in placebo; ++p<0.05 change from V8 pre-exercise versus change observed in placebo.

FIG. 10 is a chart of creatine phosphokinase (CPK) following 12 weeks of supplementation with AssuriTEA Sport (high=2 g/d, low=1 g/d) or placebo; serum measurements were taken pre and at several time points post exercise; *p<0.05 versus the within group V8 pre-exercise measurement.

FIG. 11 is a chart of cortisol following 12 weeks of supplementation with AssuriTEA Sport (high=2 g/d, low=1 g/d) or placebo; serum measurements were taken pre and at several time points post exercise; *p<0.05 versus within group pre-exercise measurement. +p<0.1 change from pre-exercise versus change observed in placebo; ++p<0.05 change from pre-exercise versus change observed in placebo.

### DESCRIPTION OF THE INVENTION

As used herein, the term “black tea” refers to plant material of the species Camellia sinensis that has been subjected to oxidation and/or fermentation. Black tea contains higher levels of theaflavins than green tea due to the condensation of flavan-3-ols during oxidation.

The term “green tea”” refers to plant material of the species Camellia sinensis that has been subjected to only minimal oxidation and/or fermentation. Green tea contains high amounts of polyphenols, including flavonoids.

The term “effective dose” or “effective amount” refers to an amount effective, at dosages and for periods of time necessary, to achieve the desired result. The effective amount of compositions of the invention may vary according to factors such as age, sex, and weight of the individual. Dosage regime may be adjusted to provide the optimum response. Several divided doses may be administered daily, or the dose may be proportionally reduced as indicated by the exigencies of an individual's situation. As will be readily appreciated, a composition in accordance with the present invention may be administered in a single serving or in multiple servings spaced throughout the day. As will be understood by those skilled in the art, servings need not be limited to daily administration, and may be on an every second or third day or other convenient effective basis. The administration on a given day may be in a single serving or in multiple servings spaced throughout the day depending on the exigencies of the situation. In preferred embodiments of the present invention, an effective dose for a human subject provides at least between 0.05 and 2 g/day and up to 4.335 g/day total polyphenols, at least between 0.0015 and 0.065 g/day and up to 0.5 g/day theaflavins and between 0.006 and 0.25 g/day epigallocatechin-3-gallate.

The term “exercise performance” refers to physical attributes which can be dependent on skeletal muscle contraction. For example, exercise performance includes, but is not limited to, running speed and endurance, muscular strength and endurance, swimming speed and endurance, maximum muscle strength, lifting strength and endurance, pulling strength and endurance and throwing strength and endurance.

The term “recovery” refers to the ability of an animal, following exercise, to return to substantially pre-exercise conditions. Compositions of the present invention improve recovery by decreasing the amount of rest required to permit a subject to return to an exercise at a pre-exercise performance and fitness level.

The term “water extract” means an extract of green or black tea wherein the only solvent used is water. The water may be heated above or cooled below ambient temperature and may be under pressure. Compositions of the present invention are water extracts of green and black tea that have been dried to a powder. The green and black tea strains and the ratios of green and black tea comprising the compositions are selected to provide a minimum of 40% by weight total polyphenols, a minimum of 1.3% by weight theaflavins, between 5 and 8 weight % epigallocatechin-3-gallate and 7-13% caffeine. The components will vary above the recited limits or within the recited ranges due to differences in growing conditions, harvest conditions, oxidation conditions and the like.

The term “muscle soreness” refers to the subjective muscle pain, aches and stiffness often experienced following a period of novel, eccentric, intense or endurance exercise. Compositions of the present invention reduce muscle soreness by decreasing the intensity of the pain or speeding the time taken for the pain to decrease or dissipate.

The term “muscle power” refers to the power that can be generated by a muscle contraction of a subject. It is common for muscle power to decrease in a subject following a period of novel, eccentric, intense or endurance exercise. Compositions of the present invention attenuate losses in muscle power by decreasing the amount of loss of muscle power or by speeding the time for the muscle power to return to pre-exercise levels.

### Methods

### Participants

We recruited 39 generally healthy male participants with a low cardiovascular disease risk factor profile with the expectations of completing 36 participants for the entire study protocol. We included men between the ages of 18-35 y who were recreationally active in both cardiovascular and resistance training; yet not exercising for more than 6 hr/wk. Training inclusion criteria required that participants be actively performing aerobic exercise, partaking in resistance training at least twice per week, and had been participating in both exercise training modalities for a minimum of 3 months. Thus, we excluded individuals who were participating in higher levels of intense exercise training.

We also excluded participants who were actively engaged in eccentric muscle training, downhill running, running >15 miles/wk or presented certain diseases such as HIV, hepatitis B and C, uncontrolled cardiovascular arrhythmias, COPD, emphysema, diabetes or unresolved orthopedic concerns. Participants were also excluded if they had a body mass index <18 or >30 or were regular consumers of medications or over-the-counter therapies that might affect inflammation such as: green or black tea (≧8 oz./d), taking a green or black tea supplement, cherry juice (≧8 oz/d), vitamin E (≧400 IU/d), vitamin C (≧1000 mg/d), aspirin, corticosteroids, anabolic steroids, or NSAIDs. We limited alcoholic beverage consumption to <3 drinks per day, and required abstinence from all tobacco products for the previous 12 months.

### Study Design

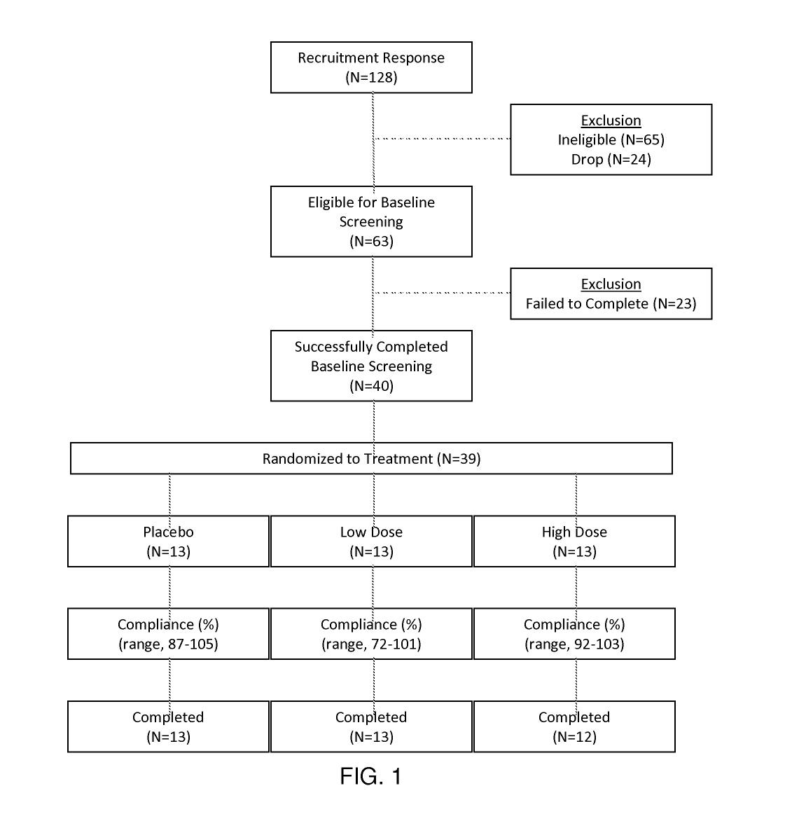

The current study included a recruiting effort, three screening familiarization visits to facilitate equipment and protocol learning and remove learning effects, and four days of criterion testing performed in the same sequence at baseline and repeated at follow-up after 12 weeks of supplementation. A CONSORT schematic outlining the overall study from recruitment through follow-up is provided (FIG. 1). The Pennington Biomedical Center Institutional Review Board approved the study. Written informed consent was obtained from all participants before any study procedures were performed.

Recruitment, Screening/Rehearsal, and Run-In Testing.

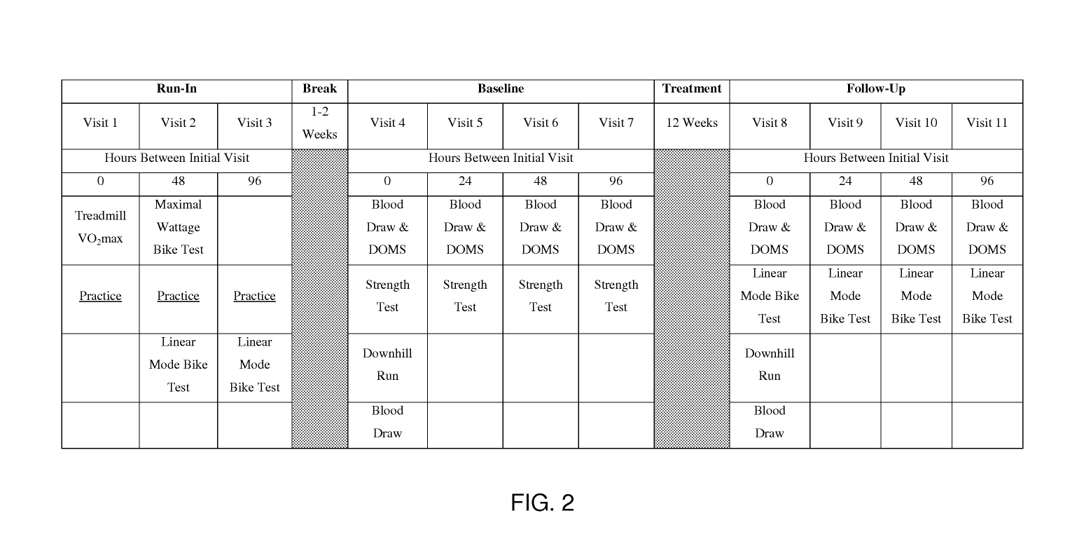

Our recruitment efforts included contacting local fitness, recreation centers and a local university where study details were posted. We also advertised in various online forums, discussion boards, and newspaper sources targeting the demographics of our study population. Upon expressing interest, potential candidates were contacted via phone and email in order to perform a basic enrollment screening. Following a successful phone screening procedure, we invited candidates to come to the Pennington Biomedical Research Center Exercise Biology Testing Core for three days of screening visits in order to practice various study protocols and to complete more in depth health history and exercise questionnaires. A schematic outlining the testing procedures is presented in FIG. 2.

During their first visit, all participants performed a treadmill running test to determine their maximal cardiorespiratory capacity (VO₂ₘₐₓ). After a 10 min rest period, this was followed by a practice Biodex leg extension muscle strength performance test. At their second visit, participants began their testing by performing a maximal bicycle ergometer test to determine their maximal power output. After 10 minutes of rest, participants practiced their muscle strength test again, rested 10 more minutes, and then practiced a linear mode bike performance test. During their third screening visit, each participant practiced both the muscle strength test and linear mode bike performance tests again. Participants were then scheduled to return for baseline testing within 1-2 weeks of their completion of Visit Three. Each participant completed an activity log throughout screening and the 1-2 week break in order to document their habitual exercise regimen.

Baseline and Follow-Up Testing.

Baseline and follow-up testing consisted of four visits each conducted between 0700 and 1200. Baseline testing was conducted during Visits 4-7 without supplementation and follow-up testing was conducted at Visits 8-11 during the 13^{th} week of supplementation (described below). Participants were asked to consume all medication as prescribed, drink at least 32 oz of water within the previous 24 hr, and abstain from alcohol for 48 hr, caffeine for 5 hr, and vigorous exercise for 24 hr prior to testing. Participants consumed a regular meal 2-3 h before each visit during the baseline and follow-up periods. Food records were completed 3 days prior to and during testing, for a total of 7 days during the baseline period. These dietary records were then collected and re-distributed during week 12 of the intervention. Participants were instructed to replicate the type and quantity of food during follow-up testing. During baseline and follow-up testing, exercise was limited to only the study protocol exercises and subjects refrained from use of ibuprofen, ice, or massage therapies.

Upon subject arrival, a standard comprehensive metabolic panel blood draw was performed to examine whether the supplement schema would adversely alter hepatorenal function (see below). An additional blood sample was also collected in order to analyze various blood indices associated with muscle damage, inflammation and oxidative stress. The participant's current delayed onset muscle soreness (DOMS) status was assessed before initiating any of the exercise protocols. Each participant was then provided with a light 120-kilocalorie snack along with 8 oz of water. During Visit 8 (Day 87), participants consumed a dose of their respective treatment on-site along with this snack. Sixty minutes later, participants performed the Biodex leg muscle strength test, rested for 10-minutes, and then performed their linear mode bike performance test. After these two tests, each participant was allowed 10 more minutes of rest before performing their downhill treadmill run. The downhill running protocol consisted of running on a treadmill at a 10% decline for 40 min at a speed associated with 65% of VO2max. Fifteen minutes following completion of the downhill treadmill run, another blood sample was collected in order to examine the acute effects of the treadmill test on blood indices associated with muscle damage, inflammation and oxidative stress. Visits 5-7 (Baseline Period) and 9-11 (Follow-up Period) took place 24 hr (visits 5 and 9), 48 hr (visits 6 and 10), and 96 hr (visits 7 and 11) after the downhill treadmill run, respectively. Upon arrival on these visit days, a blood draw was performed in order to continue the examination of indices of muscle damage, inflammation and oxidative stress. Each participant was again assessed for DOMS status, provided with a light snack and water (plus treatment during the follow-up period), and then rested 60 minutes before performing the Biodex leg muscle strength test and the subsequent linear mode bike performance test.

### Testing Procedures

Maximal Cardiorespiratory Testing.

For the VO₂ₘₐₓ test, we used a “running” protocol. Our decision to perform the test in this manner was based on our desire to prescribe a downhill running speed based on 65% of VO₂ₘₐₓ running speed (detailed below). Therefore, it was important to achieve this speed on a flat running surface. To achieve this goal, we initiated testing at a controlled walking speed of 2.5 mph before progressing to 3.5 mph and then to 4.5 mph. From this point on, we progressed speed by the participants choice using a series of hand signals to determine the next speed. Each stage performed on a flat surface was 3-min in duration and proceeded as such until the participant achieved of respiratory exchange ratio of 1.0. Once the respiratory exchange ratio reached 1.0, the speed was held constant and grade was increased by 1% every minute until volitional fatigue. All treadmill tests were monitored with a 12-lead ECG for heart rate and oxygen consumption via open circuit spirometry using a Parvomedics TrueMax Metabolic System (Salt Lake City, Utah).

Biodex Leg Muscle Strength.

All muscle strength tests were performed on a Biodex System 3 dynamometer (Biodex Medical Systems, Shirley, N.Y.). Our aim for this test was to choose a muscle group most likely affected by downhill treadmill running and a resistance that best emulated a traditional repetition schema for recreational resistance training. To accomplish this, we had participants perform 3 sets of quadriceps leg extension on their dominant leg for 12 repetitions at 120 degrees/sec. Each set was interspersed with 2 minutes of rest and a DOMS assessment was performed after each set of exercise. Peak torque (highest repetition, N m), low torque (the average of the 3 consecutive lowest repetitions at the end of the set, N m), total work (N m), average power (Watts), and the fatigue index (%), defined as the high torque (the average of the 3 consecutive highest repetitions at the beginning of the set) minus the low torque, divided by the high torque, was calculated for each set of exercise. For each of these variables, the average (or sum) of three sets was used to represent a single visit.

Delayed Onset Muscle Soreness (DOMS).

Muscle soreness was assessed using a 7 point Likert scale for a variety of muscle groups including the gastrocnemius, hamstrings, quadriceps, gluteus maximus, lower back, abdominals, and whole body. Participants were asked to rate their perceived level of muscle soreness at rest as (1) No pain, (2) Dull ache, (3) Slight pain, (4) Moderate pain, (5) Painful, (6) Very painful, or (7) Severe pain. At each of the baseline and follow-up visits, DOMS was assessed immediately following the pre-test blood draw, after each of the three sets of the Biodex leg muscle strength test, after the bike performance test, and upon completion of the downhill run.

Maximal Bike Wattage Test.

Maximal power output (PO; Watts) was determined using a maximal wattage bike test on a Lode Excalibur Sport Ergometer (Groningen, The Netherlands). This test was conducted to determine the resistance setting for the linear mode bike performance test that participants would perform during baseline testing. During the maximal PO test, participants began their protocol with a brief 5-minute warm-up at 50 watts and then we increased wattage at a rate of 25 watts per minute (2.4 W/sec) until volitional fatigue.

Linear Mode Bike Performance Test.

Each participant rode at his own cadence on a Lode Ergometer for 25 minutes. The Lode ergometer as set to “linear mode” using the formula linear setting=max wattage/rpm² and each participant was asked to pedal as fast as possible for the length of the test. The rationale for using linear mode is that this mode accounts for slower or faster pedaling cadences where slower cadences are reflected by lower power output (i.e., energy expenditure) and higher cadences result in higher caloric expenditures. Total energy expenditure (kilojoules), average power output, average heart rate, and average RPM were recorded during each test. Thus, if supplementation improved work performance, supplemented riders should be able to work harder and burn more energy during this 25-min bike performance test. A DOMS assessment was performed following this ride.

Blood Chemistries.

We obtained blood samples at the time points shown on FIG. 2 for two reasons. A primary reason for the blood draw was to evaluate the safety of and tolerance to the dietary supplement through a comprehensive metabolic panel prior to testing procedures on Visits 4 and 8. The analytes we measured included: potassium, uric acid, albumin (ALB), calcium, magnesium, alanine aminotransferase (ALT), alkaline phosphatase (ALK), iron, and total cholesterol.

Secondly, we also wished to examine potential mechanisms of action observed during treatment. Potential mechanisms of action evaluated were indices of inflammation (IL-6, IL-10, TNFa), muscle damage (lactate dehydrogenase [LDH], creatine phosphokinase [CK]), oxidative stress (8-isoprostane, Ferric Reducing Ability of Plasma [FRAP]), and hormonal indices associated with muscle catabolism (cortisol and adrenocorticotropic hormone). These markers were examined prior to testing procedures at Visits 4-11, and post-downhill run at Visits 4 and 8. Whole blood was collected and serum was isolated, banked, and stored at −80° C. to be analyzed in batch at the end of the study.

Accordingly, IL-6, IL-10 and TNFa were assayed from frozen serum samples using an immunoassay with fluorescent detection (Luminex Labmap 100, Linco, St. Charles, Mo., USA). Lactate dehydrogenase, creatine phosphokinase were analyzed from frozen serum using an immunoassay with chemiluminescent detection (Beckman Coulter DXC600, Brea, Calif., United States). Cortisol and adrenocorticotropic hormone were analyzed using immunoassay chemiluminescent detection on an Immulite 2000 (Siemens, Tarrytown, N.Y., United States). FRAP was measured by a colorometric assay (Beckman Coulter DXC600) and 8-isoprostate was measured by enzyme immunoassay (Tarrytown, N.Y., United States).

Treatment.

After baseline testing during Visit 7, all participants were randomly assigned to one of three treatments in a double blind, placebo controlled, parallel group order assignment technique by a pharmacist at Pennington Biomedical Research Center. The two active study groups consumed different doses of AssuriTEA® Sport (ATS, Kemin Foods, L.C., Des Moines, Iowa), a proprietary blend of water-extracted green and black teas. The treatment groups were: (1) A control group receiving a placebo treatment matched for color and capsule size to the treatment conditions, (2) A low-dose group receiving 1 g/d; 4 capsules×250 mg of ATS tea extracts plus 250 mg of inert filler, and (3) A high-dose group receiving 2 g/d; 4 capsules×500 mg of ATS tea extract without fillers matched for color and size to the treatment conditions. ATS was standardized to contain a minimum 40% total polyphenols, minimum 1.3% theaflavins, 5-8% epigallocatechin-3-gallate, and 7-13% caffeine. The study agent was formulated under Good Manufacturing Practices, produced, encapsulated and packaged in light resistant plastic bottles. The product lots were tested for toxins including heavy metals, pesticides and excipients. Stability of the capsules was confirmed throughout the study period (data not shown).

To attain the required dose, participants ingested 2 gelatin capsules twice per day with a morning and evening meal. Supplements were administered in bottles with enough supplements to last one month. Participants then returned at the end of each month to obtain new supplements, allowing us to count capsules against a known quantity of administered treatment capsules in order to assess compliance. A priori, we considered compliance as ingesting >80% of all administered capsules. We asked participants to maintain the same exercise and dietary habits during the intervention as reported during screening. We also contacted participants on a weekly basis by phone or e-mail to ask about any adverse events, and encourage compliance and maintenance of exercise and dietary habits.

### Statistics.

All outcome variables were analyzed using a repeated measures mixed model analysis of variance containing the main effect of treatment, the main effect of visit, and the treatment×visit interaction. This model was used in two ways.

First, least squares (LS) means using change scores from baseline visits (visits 4-7) to the final visits (i.e., visit 8 minus visit 4, visit 9 minus visit 5, etc.) were evaluated. Each overall main effect and interaction term was examined for statistical significance (p≦0.05). Significance levels for contrasts (high vs. low, high vs. placebo, low vs. placebo) were consulted to facilitate the interpretation of the corresponding overall interaction. Analyses of this type will be called “across treatment” analyses because the dependent variable under analysis was formed by subtracting a pre-treatment baseline score from a post treatment outcome score.

Second, change scores reflecting only post treatment recovery were constructed by subtracting visit 8 from visits 9, 10 and 11. Analyses corresponding in kind to those described immediately above were applied to these change scores. These analyses will be called “post treatment” analyses because the dependent variable was formed by subtracting a baseline value originating immediately after treatment (visit 8) from a second score originating at a later time after treatment (visits 9, 10 or 11).

Although significance levels specifically refer to effects, interactions and contrasts formed from comparisons based on model predicted means (i.e., the LS Means), corresponding means with other descriptive statistics have been provided that are based on raw data values. Demographics and performance variables will be analyzed for both the intent to treat and the evaluable groups, while secondary outcomes will only be evaluated in the evaluable groups.

### Results

### Across Treatment

Biodex Peak Torque.

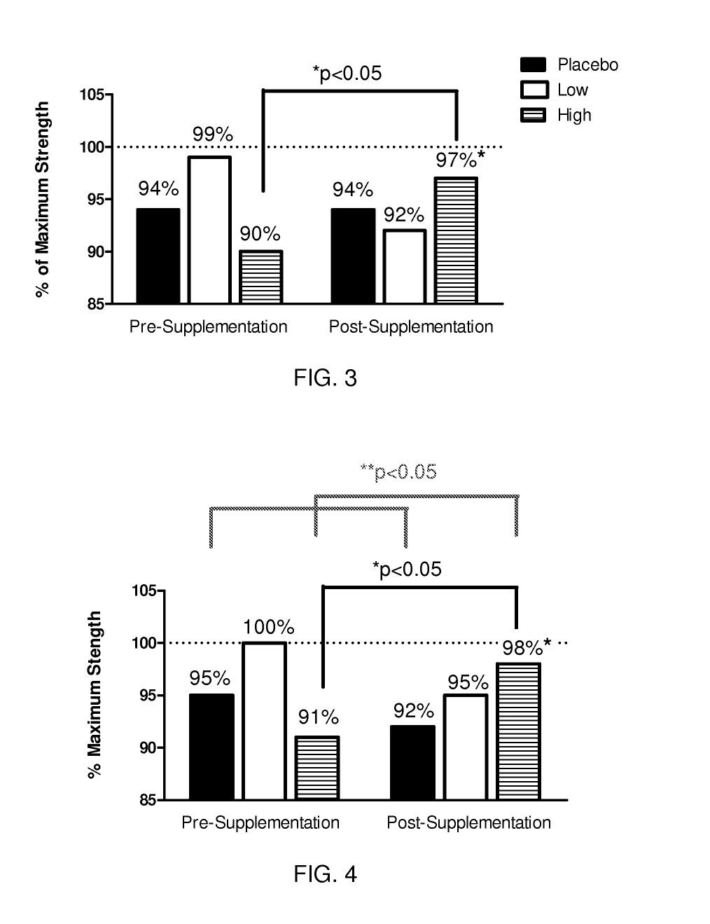

The overall model of analysis of variance for the evaluation of treatment×visit for peak torque was significant (p=0.043). Supplementation for 12 weeks with 2 g of ATS significantly increased peak torque observed 24 hours post exercise (visit 9) compared to baseline (visit 5) measurement (FIG. 3, p=0.036). At 48 hours post exercise (vist 10), supplementation with 2 g of ATS significantly increase peak torque compared to baseline (visit 6) measurement (FIG. 4, p=0.026). In addition, at 48 hours this change from the baseline was statistically significant compared to the change observed for the placebo group (p=0.011). No changes were observed in the 2 g ATS group at the 96 hour timepoint and no changes at any timepoints were identified in the 1 g ATS group for Biodex peak torque.

Biodex Average Power.

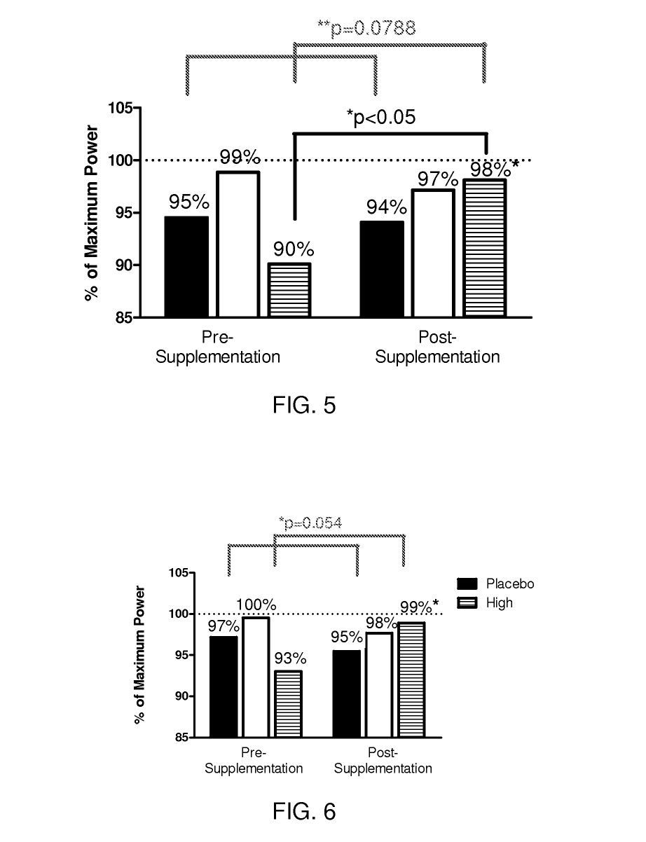

The overall model of analysis of variance for the evaluation of treatment×visit for peak torque was significant (p=0.0295). Supplementation with 2 g of ATS for 12 weeks results in increased power as measured by Biodex at 24 hours post exercise (visit 9) compared to visit 5 (FIG. 5, p=0.0162). This change from baseline that occurred following 2 g of ATS trended to increase (p=0.0788) compared to the change observed for the placebo group. At 48 hours post exercise, the change from the baseline week measurements trended (p=0.054) to increase compared to the change observed in the placebo group (FIG. 6). Biodex power showed no changes at the 96 hour timepoint for the 2 g ATS group and no changes at any timepoints were identified in the 1 g ATS group.

Biodex Minimum Torque.

Supplementation with 1 g of ATS for 12 weeks resulted in an increase in the observed change in the Biodex minimum torque at 24 hours post exercise (visit 9 versus visit 5) compared to the change observed in the placebo (FIG. 6, p=0.0518). No changes in Biodex minimum torque were identified at 24 hours for the 2 g ATS group and no changes at 48 or 96 hours were identified at any dose evaluated.

Additional Biodex Measurements.

No differences were identified for work or fatigue for any of the doses evaluated.

### DOMS.

Linear Mode Bike Performance Test.

No differences were identified for total energy expenditure (kilojoules), average power output, average heart rate, and average RPM were recorded during each test.

Blood Measurements.

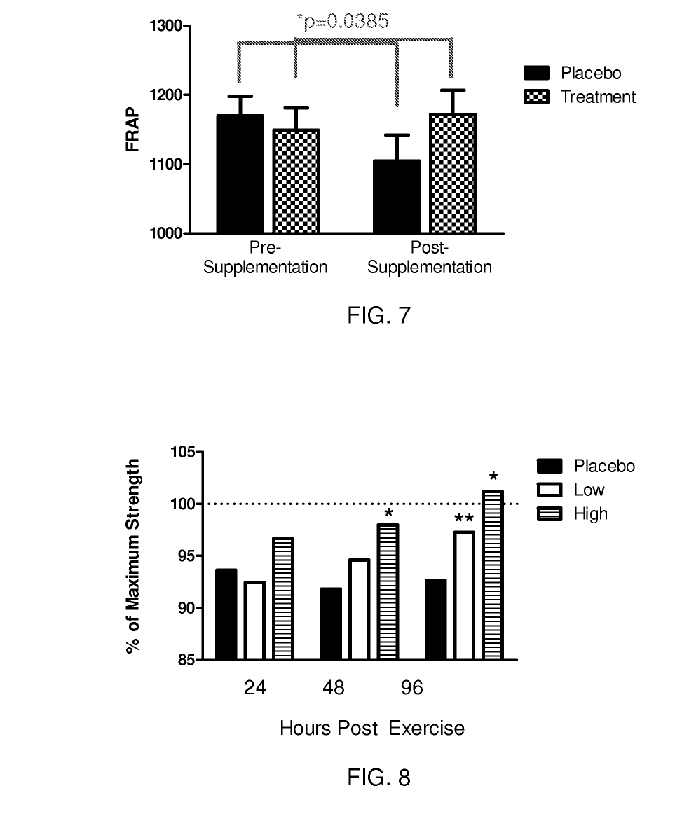

The change from baseline (visit 8-visit 4) in serum antioxidant status, as measured by FRAP, was increased in the treatment group (with both 1 g and 2 g treatments combined) in comparison to the change observed in the placebo group (FIG. 7, p=0.035). No changes were identified post supplementation in comparison to pre-supplementation for Cortisol, ACTH, IL-6, IL-10, TNFa, Isoprostanes, CPK or LDH.

### Post Treatment.

Biodex Peak Torque. Biodex Peak Torque.

The overall model of analysis of variance for the evaluation was significant for treatment (p=0.022). Following 12 weeks of supplementation, peak torque was significantly decreased within the placebo group at 24 (visit 9), 48 (visit 10), and 96 (visit 11) hours compared to pre-exercise (visit 8) peak torque (p=0.0013, p<0.0001, p=0.0003, respectively). Twelve weeks of supplementation with 1 g of ATS resulted in significantly decreased peak torque within group at 24 and 48 hours post exercise (p=0.0004 and p=0.010, respectively) compared to pre-exercise peak torque; however, at 96 hours the peak torque levels were equivalent to the pre-exercise values. Supplementation for 12 weeks with 2 g ATS resulted in no significant within group decreases in the peak torque values at any timepoint post exercise compared to pre exercise.

Between group differences were also identified for peak torque. The decreased observed in peak torque for placebo group was significantly greater than the decrease observed in the 2 g ATS group at 48 and 96 hours post exercise (p=0.012 and p=0.0031, respectively, FIG. 8). In addition, the decrease in peak torque observed in the placebo group trended to be greater than the decrease in peak torque following 12 week administration of 1 g of ATS (p=0.0945).

DOMS.

Differences in DOMS upon arrival for daily testing (pre-Biodex) were identified between groups at 24 (visit 9) and 48 (visit 10) hours post exercise following 12 weeks of supplementation in comparison to pre-exercise (visit 8) levels. At 24 hours post exercise, subjects administered 2 g of ATS reported a trend to decreased muscle soreness in quadriceps and whole body (p=0.056 and p=0.070, respectively) compared to placebo. At 48 hours, administration of 2 g of ATS resulted in a trend towards decreased muscle soreness in quadriceps (p=0.056), and significantly decreased hamstring (p=0.029) and whole body muscle soreness (p=0.029). In addition, supplementation for 12 weeks with 1 g of ATS resulted in a trend (p=0.098) to decreased hamstring soreness at 48 hours post exercise.

Blood Measurements.

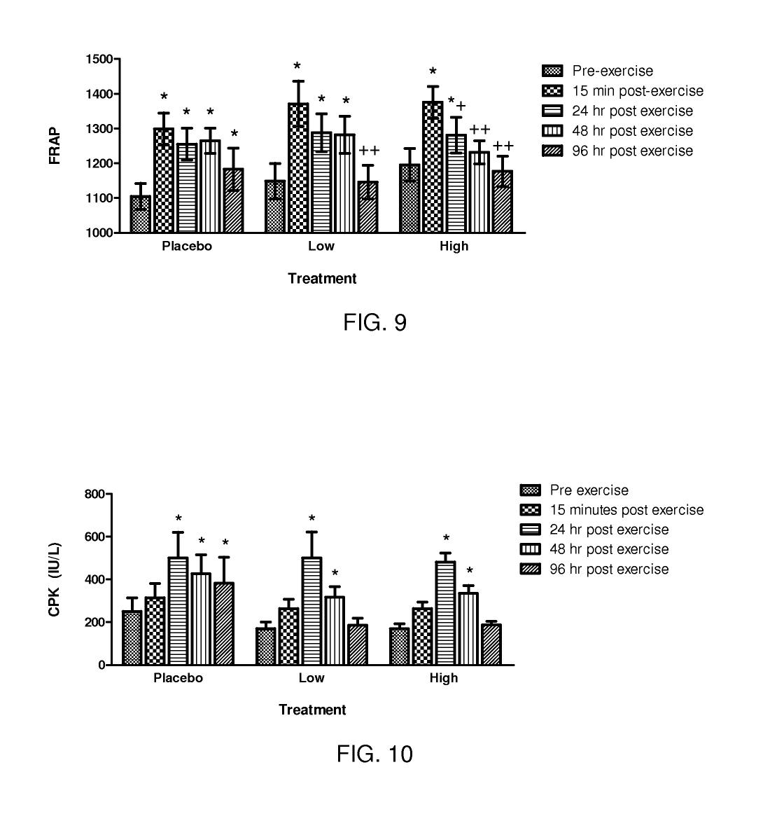

As detailed above, 12 weeks of supplementation resulted in increased serum antioxidant status prior to introduction of any exercise component (visit 4 pre-exercise versus visit 8 pre-exercise). However, evaluation of post-exercise serum antioxidant status (visits 9-11) in comparison to pre-exercise levels (visit 8) following supplementation for 12 weeks identified overall treatment effects (p=0.006, FIG. 9). Within group differences for serum FRAP from pre-exercise values were found for all groups. Supplementation with 2 g ATS for 12 weeks results in increased FRAP at 15 minutes and 24 hours post exercise, p<0.001 and p=0.0025, respectively, compared to pre-exercise levels; however, at 48 and 96 hours FRAP levels were not different than pre-exercise values. Supplementation with 1 g ATS increased serum FRAP at 15 minutes, 24 and 48 hours post exercise, (all p<0.0001) compared to pre-exercise levels, but was no different than pre-exercise levels at 96 hours. The placebo group had significantly (p<0.005) increased serum FRAP at all time points post exercise in comparison to pre-exercise levels. Evaluation of the between group effects for serum FRAP identified that the change from pre-exercise levels for the 2 g ATS supplementation group was significantly less than the change that occurred in the placebo group at 48 and 96 hours (p=0.002 and p=0.013, respectively) and trended at 24 hours (p=0.092). Furthermore, at 96 hours the change from pre-exercise values that occurred in the group supplemented for 12 weeks with 1 g of ATS was significantly (p=0.038) less than placebo.

As expected, CPK and Cortisol increased post exercise in all groups. Analysis of CPK values identified within group differences when post exercise values (visits 9-11) were compared to the pre-exercise values from visit 8 (FIG. 10). Supplementation for 12 weeks with 2 g ATS resulted in CPK values at 24 and 48 hours post exercise significantly greater than pre-exercise values (p<0.001 and p=0.002, respectively); however, by 96 hours post exercise CPK values were not different than pre-exercise levels. This same finding occurred in subjects administered 1 g of ATS for 12 weeks (p<0.001[24 hours] and p=0.006[48 hours]). Subjects administered placebo for 12 weeks had increased CPK values at 24 (p<0.001), 48 (p=0.001) and 96 (p=0.010) hours post exercise in comparison to pre-exercise levels, with CPK not returning to pre-exercise levels.

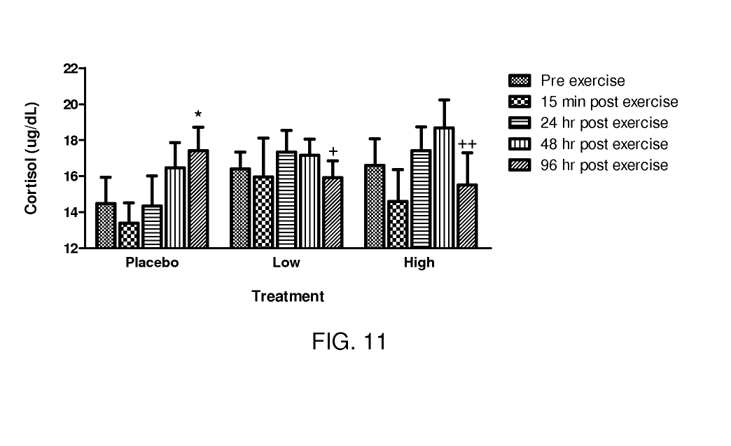

While cortisol increased in all groups post exercise, between group differences were identified at 96 hours post-exercise (FIG. 11). In the group administered placebo for 12 weeks, at 96 hours (visit 11) post exercise cortisol levels were continuing to increase in comparison to pre-exercise (visit 8) levels (p=0.026). Furthermore, at 96 hours the increased cortisol in the placebo group was significantly greater than the change reflected in the group administered 2 g ATS for 12 weeks (p=0.039) and trended to be greater than the 1 g ATS group (p=0.078).

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art who have the disclosure before them will be able to make modifications and variations therein without departing from the scope of the invention.

### REFERENCES

1. Connolly D A, Lauzon C, Agnew J, Dunn M, Reed B. The effects of vitamin C supplementation on symptoms of delayed onset muscle soreness. The Journal of sports medicine and physical fitness. September 2006; 46(3):462-467.
2. McHugh M P, Connolly D A, Eston R G, Gartman E J, Gleim G W. Electromyographic analysis of repeated bouts of eccentric exercise. Journal of sports sciences. March 2001; 19(3):163-170.
3. McHugh M P, Connolly D A, Eston R G, Gleim G W. Electromyographic analysis of exercise resulting in symptoms of muscle damage. Journal of sports sciences. March 2000; 18(3):163-172.
4. Eston R G, Mickleborough J, Baltzopoulos V. Eccentric activation and muscle damage: biomechanical and physiological considerations during downhill running. Br J Sports Med. June 1995; 29(2):89-94.
5. Maughan R J, Donnelly A E, Gleeson M, Whiting P H, Walker K A, Clough P J. Delayed-onset muscle damage and lipid peroxidation in man after a downhill run. Muscle Nerve. April 1989; 12(4):332-336.
6. Connolly D A, Sayers S P, McHugh M P. Treatment and prevention of delayed onset muscle soreness. Journal of strength and conditioning research/National Strength & Conditioning Association. February 2003; 17(1):197-208.
7. Pyne D B. Exercise-induced muscle damage and inflammation: a review. Aust J Sci Med Sport. September-December 1994; 26(3-4):49-58.
8. Arent S M, Senso M, Golem D L, McKeever K H. The effects of theaflavin-enriched black tea extract on muscle soreness, oxidative stress, inflammation, and endocrine responses to acute anaerobic interval training: a randomized, double-blind, crossover study. J Int Soc Sports Nutr. 2010; 7(1):11.
9. Connolly D A, McHugh M P, Padilla-Zakour O I, Carlson L, Sayers S P. Efficacy of a tart cherry juice blend in preventing the symptoms of muscle damage. Br J Sports Med. August 2006; 40(8):679-683; discussion 683.
10. Babu P V, Liu D. Green tea catechins and cardiovascular health: an update. Current medicinal chemistry. 2008; 15(18):1840-1850.
11. Eichenberger P, Colombani P C, Mettler S. Effects of 3-week consumption of green tea extracts on whole-body metabolism during cycling exercise in endurance-trained men. Int J Vitam Nutr Res. January 2009; 79(1):24-33.
12. Higdon J V, Frei B. Tea catechins and polyphenols: health effects, metabolism, and antioxidant functions. Crit Rev Food Sci Nutr. 2003; 43(1):89-143.
13. Ichinose T, Nomura S, Someya Y, Akimoto S, Tachiyashiki K, Imaizumi K. Effect of endurance training supplemented with green tea extract on substrate metabolism during exercise in humans. Scand J Med Sci Sports. Mar. 10, 2010.
14. Stangl V, Lorenz M, Stangl K. The role of tea and tea flavonoids in cardiovascular health. Mol Nutr Food Res. February 2006; 50(2):218-228.
15. Gonzalez-Gallego J, Garcia-Mediavilla M V, Sanchez-Campos S, Tunon M J. Fruit polyphenols, immunity and inflammation. Br J. Nutr. October 2010; 104 Suppl 3:S15-27.
16. Luczaj W, Skrzydlewska E. Antioxidative properties of black tea. Prev Med. June 2005; 40(6):910-918.
17. Nag Chaudhuri A K, Karmakar S, Roy D, Pal S, Pal M, Sen T. Anti-inflammatory activity of Indian black tea (Sikkim variety). Pharmacol Res. February 2005; 51(2):169-175.
18. Aneja R, Odoms K, Denenberg A G, Wong H R. Theaflavin, a black tea extract, is a novel anti-inflammatory compound. Crit Care Med. October 2004; 32(10):2097-2103.
19. Kris-Etherton P M, Keen C L. Evidence that the antioxidant flavonoids in tea and cocoa are beneficial for cardiovascular health. Curr Opin Lipidol. February 2002; 13(1):41-49.
20. Eichenberger P, Mettler S, Arnold M, Colombani P C. No effects of three-week consumption of a green tea extract on time trial performance in endurance-trained men. Int J Vitam Nutr Res. January 2010; 80(1):54-64.
21. Murase T, Haramizu S, Shimotoyodome A, Tokimitsu I, Hase T. Green tea extract improves running endurance in mice by stimulating lipid utilization during exercise. Am J Physiol Regul Integr Comp Physiol. June 2006; 290(6):R1550-1556.
22. Call J A, Voelker K A, Wolff A V, et al. Endurance capacity in maturing mdx mice is markedly enhanced by combined voluntary wheel running and green tea extract. J Appl Physiol. September 2008; 105(3):923-932.
23. Mullin G E. Comment on: Black and Green Tea Consumption and the Risk of Coronary Artery Disease: A Meta-Analysis: A Meta-Analysis. Nutrition in clinical practice: official publication of the American Society for Parenteral and Enteral Nutrition. Apr. 20 2011.
24. Murase T, Haramizu S, Shimotoyodome A, Nagasawa A, Tokimitsu I. Green tea extract improves endurance capacity and increases muscle lipid oxidation in mice. Am J Physiol Regul Integr Comp Physiol. March 2005; 288(3):R708-715.
25. Panza V S, Wazlawik E, Ricardo Schutz G, Comin L, Hecht K C, da Silva E L. Consumption of green tea favorably affects oxidative stress markers in weight-trained men. Nutrition. May 2008; 24(5):433-442.
26. Venables M C, Hulston C J, Cox H R, Jeukendrup A E. Green tea extract ingestion, fat oxidation, and glucose tolerance in healthy humans. Am J Clin Nutr. March 2008; 87(3):778-784.
27. Cohen J. A power primer. Psychological Bulletin. 1992; 112(1):155-159.

We claim:

1. A composition comprising a blend of extracts of green tea and black tea which, upon administration to subjects in an effective dose and over an effective period, improves exercise performance and recovery.

2. The composition as claimed in claim 1, wherein the blend is between 20% and 70% green tea extract and between 80% and 30% black tea extract.

3. The composition as claimed in claim 2 wherein the extracts are water extracts.

4. The composition as claimed in claim 1, wherein the composition comprises a minimum of 40% by weight total polyphenols, a minimum of 1.3% by weight theaflavins and 5-8% by weight epigallocatechin-3-gallate.

5. A method of attenuating losses in performance or strength following activity or exercise in a mammal, comprising administering an effective amount of the composition of claim 1.

6. The method of claim 5, wherein the effective amount is between 0.5 g/day and 5 g/day in a human subject.

7. A method of attenuating losses in power following activity or exercise in a mammal, comprising administering an effective amount of the composition of claim 1.

8. The method of claim 7, wherein the effective amount is between 0.5 g/day and 5 g/day in a human subject.

9. A method of reducing muscle soreness in a human, comprising administering an effective amount of the composition of claim 1.

10. The method of claim 9, wherein the effective amount is between 0.5 g/day and 5 g/day in a human subject.
